(19) United States
(12) Patent Application Publication
(10) Pub. No.: US 2007/0282559 A1
(43) Pub. Date: Dec. 6, 2007

(54) MULTIMEDIA DEVICE TEST METHOD

(75) Inventor: PAI-CHEN LIU, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Taipei Hsien (TW)

(21) Appl. No.: 11/616,870

(22) Filed: Dec. 28, 2006

(30) Foreign Application Priority Data
Jun. 2, 2006 (TW) 95119639

(51) Int. Cl. G06F 19/00

(52) U.S. Cl. 702/124; 702/108; 702/1; 702/127; 702/189

(57) ABSTRACT

A multimedia device test method is provided. The multimedia device test method includes generating parameters of a reference signal and a measured signal via a computer; creating multiple sub-files of the reference signal and multiple sub-files of the measured signal according to corresponding parameters via the computer; combining the multiple sub-files of the reference signal and the multiple sub-files of the measured signal into one composite file with a composite test signal via the computer; compiling the file of the composite test signal as an object executable file via the computer; executing the object executable file via a test signal generator for generating a frame including parameters of the composite test signal, and the frame is then transmitted to the multimedia device for outputting the composite test signal; and providing an analyzer to analyze the output composite test signal.

### BACKGROUND OF THE INVENTION

1. Field of the Invention

The present invention relates to a test method, and particularly to a multimedia device test method.

2. Related of Prior Art

A system test is necessary after a multimedia device, such as a set top box (STB), a wireless television, or a video phone, is manufactured. The system test includes testing quality of a video signal processed by the multimedia device. That is, a test signal generator generates a frame including multiple test signals, such as a Moving Picture Experts Group (MPEG) frame, and transmits the frame to the multimedia device to process the frame. Then a video signal analyzer analyzes the frame processed by the multimedia device. At present, most countries around the world follow one of three main video broadcast standards, which are National Television Standards Committee (NTSC), Phase Alternating Line (PAL), and Sequential Color and Memory (SECAM). The test signals respectively correspond to each of the video broadcast standards.

When the above-mentioned multimedia device is used to process an MPEG frame, the frame is firstly converted into a digital format, then is converted back to an analogue format. After the movie is converted two times, a blocking effect may appear, which makes the test result unreliable.

Therefore, a heretofore unaddressed need exists in the industry to make the multimedia device test more reliable.

### SUMMARY OF THE INVENTION

A multimedia device test method is provided. The multimedia device test method includes generating parameters of a reference signal and a measured signal via a computer; creating multiple sub-files of the reference signal and multiple sub-files of the measured signal according to corresponding parameters via the computer; combining the multiple sub-files of the reference signal and the multiple sub-files of the measured signal into one composite file with a composite test signal via the computer; compiling the file of the composite test signal as an object executable file via the computer; executing the object executable file via a test signal generator for generating a frame including parameters of the composite test signal, and the frame is then transmitted to the multimedia device to process, for output of the composite test signal; and providing an analyzer to analyze the output composite test signal.

Other objectives, advantages and novel features of the present invention will be drawn from the following detailed description of preferred embodiments of the present invention with the attached drawings, in which:

### BRIEF DESCRIPTION OF THE DRAWINGS

FIG. 1 is a flowchart of testing a multimedia device in accordance with an exemplary embodiment of the present invention.

### DETAILED DESCRIPTION OF THE INVENTION

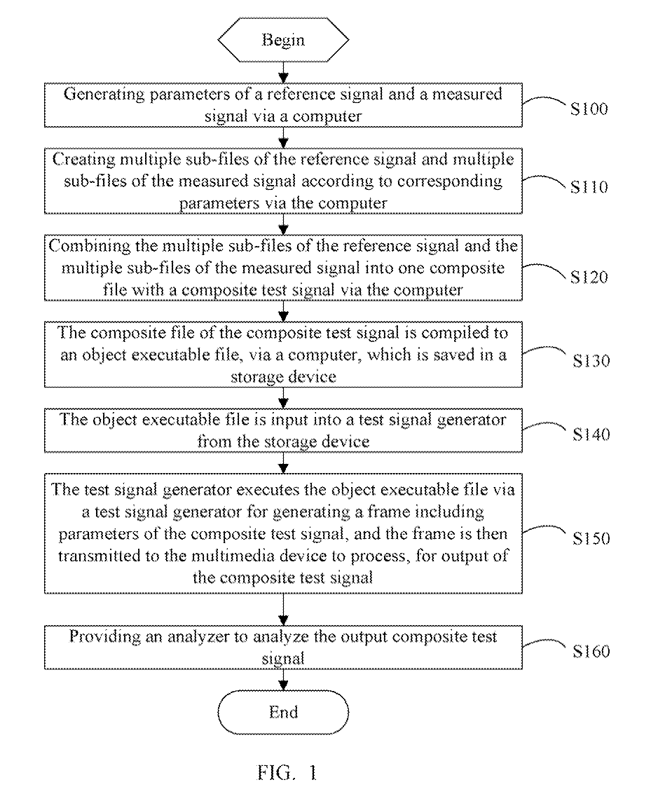

FIG. 1 is a flowchart of testing a multimedia device in accordance with an exemplary embodiment of the present invention.

In step S100, generating a reference signal and a measured signal by editing parameters thereof via a computer.

In this exemplary embodiment, a test signal with the smallest amplitude, such as an institute of radio engineers (IRE) 0 test signal of NTSC standard, is regarded as a reference signal, because the test signal with the smallest amplitude interferes with the measured signal least. The IRE is a type of unit measurement used on a television waveform monitor for measuring signal level. The measured signal is selected randomly, such as a color bar 75% test signal of the NTSC standard. The reference signal and the measured signal include three parameters, which are sync level, color burst, and white level all represented by IRE.

In step S110, creating multiple sub-files of the reference signal and multiple sub-files of the measured signal according to corresponding parameters via the computer.

In this exemplary embodiment, an amount of the sub-files of the reference signal is 10, and an amount of the sub-files of the measured signal is 9. The file extensions of all the sub-files are all set to “.EQN”.

In step S120, combining the multiple sub-files of the reference signal and the multiple sub-files of the measured signal into one composite file with a composite test signal via the computer. In this exemplary embodiment, the file extension of the composite file is set to “.MEM”.

In this exemplary embodiment, 10 sub-files of the reference signal and 9 sub-files of the measured signal are combined into one composite file with a composite test signal via the computer. For example, an NTSC interlace video includes an odd field of 262 scan lines, and an even field of 263 scan lines. Typically, the first twenty scan lines of the odd field and the even field respectively are not employed in a test, because those scan lines are vertical blanking interval scan lines, which are not shown on a screen. Therefore, only the 21^{st} to the 262^{nd} scan lines of the odd field, and the 284^{th} to the 525^{th} scan lines of the even field, as shown in table 1, are tested.

The scan lines of the odd field and the even field are divided into 19 groups according to Table 1, and the IRE 0 test signal and the Color Bar 75% test signal are displayed alternately. Each group corresponds to a sub-file.

The 1^{st}, 3^{rd}, 5^{th}, 7^{th}, 9^{th}, 11^{th}, 13^{th}, 15^{th}, and the 17^{th} groups of the odd field and the even field includes 20 scan lines, and all of the 20 scan lines are used to display the IRE 0 test signal. Furthermore, the 19^{th} groups of the odd field and the even field include 7 scan lines, and all of the 7 scan lines are used to display the IRE 0 test signal.

The 2^{nd}, 4^{th}, 6^{th}, 8^{th}, 10^{th}, 12^{th}, 14^{th}, 16^{th}, and the 18^{th} groups of the odd field and the even field includes 1, 2, 3, 4, 5, 6, 7, 8, and 9 scan lines, respectively, and all of the scan lines are used to display the Color Bar 75% test signal.

TABLE 1

| | | | | Numbers |
|---|---|---|---|---|
| Group | | | | of Scan |
| Sequence | Odd Field | Even Field | Test Signal | lines |
| 1 | 21~41 | 284~304 | IRE 0 | 20 |
| 2 | 42~42 | 305~305 | Color Bar 75% | 1 |
| 3 | 43~63 | 306~326 | IRE 0 | 20 |
| 4 | 64~65 | 327~328 | Color Bar 75% | 2 |
| 5 | 66~86 | 329~349 | IRE 0 | 20 |
| 6 | 87~89 | 350~352 | Color Bar 75% | 3 |
| 7 | 90~110 | 353~373 | IRE 0 | 20 |
| 8 | 111~114 | 374~377 | Color Bar 75% | 4 |
| 9 | 115~135 | 378~398 | IRE 0 | 20 |
| 10 | 136~140 | 399~403 | Color Bar 75% | 5 |
| 11 | 141~161 | 404~424 | IRE 0 | 20 |
| 12 | 162~167 | 425~430 | Color Bar 75% | 6 |
| 13 | 168~188 | 431~451 | IRE 0 | 20 |
| 14 | 189~195 | 452~458 | Color Bar 75% | 7 |
| 15 | 196~216 | 459~479 | IRE 0 | 20 |
| 16 | 217~224 | 480~487 | Color Bar 75% | 8 |
| 17 | 225~245 | 488~508 | IRE 0 | 20 |
| 18 | 246~254 | 509~517 | Color Bar 75% | 9 |
| 19 | 255~262 | 518~525 | IRE 0 | 7 |

A file of the composite test signal including multiple programs or sub-files can be designed according to table 1. The programs can be written in a C language or a script language and so on.

In step S130, the composite file of the composite test signal is compiled as an object executable file, via a computer, which is saved in a storage device.

In detail, firstly, the file of the composite test signal is compiled as an object executable file via a computer; secondly, a path and a name are set for the object executable file via the computer; lastly, the object executable file is saved in a storage device, such as a floppy disc, a flash memory, or a compact disc.

In step S140, the object executable file is input into a test signal generator from the storage device. In this embodiment, the object executable file is input into the test signal generator from the floppy disc.

In step S150, the test signal generator executes the object executable file via a test signal generator for generating a frame including parameters of the composite test signal, and the frame is then transmitted to the multimedia device to process, for output of the composite test signal. In this embodiment, the frame of the composite test signal includes parameters of the reference signal and the measured signal. The frame generated by the test signal generator is an MPEG frame.

In step S160, providing an analyzer to analyze the output composite test signal.

In this embodiment, the analyzer is used to measure a color vector of the Color Bar 75% test signal.

Table 2 shows results of measuring the composite test signal processed by the multimedia device. As shown in Table 2, in all groups the first and last scan lines always fail. Moreover, in the groups with five or more scan lines, the first scan line, the second scan line, the last scan line, and the scan line next to the last may fail. Therefore, to ensure reliable results, only the scan lines in the groups with five or more scan lines should be measured except the first scan line, the second scan line, the last scan line, and the scan line next to the last. The first scan line, the second scan line, the last scan line, and the scan line next to the last are called guard scan lines, and the rest are called measured scan lines. In this embodiment, the analyzer measures a color vector of the measured scan lines of the Color Bar 75% test signal.

TABLE 2

| | |
|---|---|
| Group | Scan Line Sequence |

| Sequence | Odd Field | Even Field | Result |
|---|---|---|---|
| 2 | 42 | 305 | Failed |
| 4 | 64 | 327 | Failed |
| | 65 | 328 | Failed |
| 6 | 87 | 350 | Failed |
| | 88 | 351 | Pass |
| | 89 | 352 | Failed |
| 8 | 111 | 374 | Failed |
| | 112 | 375 | Pass |
| | 113 | 376 | Failed |
| | 114 | 377 | Failed |
| 10 | 136 | 399 | Failed |
| | 137 | 400 | Failed |
| | 138 | 401 | Pass |
| | 139 | 402 | Failed |
| | 140 | 403 | Failed |
| 12 | 162 | 425 | Failed |
| | 163 | 426 | Failed |
| | 164 | 427 | Pass |
| | 165 | 428 | Pass |
| | 166 | 429 | Pass |
| | 167 | 430 | Failed |
| 14 | 189 | 452 | Failed |
| | 190 | 453 | Pass |
| | 191 | 454 | Pass |
| | 192 | 455 | Pass |
| | 193 | 456 | Pass |
| | 194 | 457 | Pass |
| | 195 | 458 | Failed |
| 16 | 217 | 480 | Failed |
| | 218 | 481 | Pass |
| | 219 | 482 | Pass |
| | 220 | 483 | Pass |
| | 221 | 484 | Pass |
| | 222 | 485 | Pass |
| | 223 | 486 | Failed |
| | 224 | 487 | Failed |
| 18 | 246 | 509 | Failed |
| | 247 | 510 | Failed |
| | 248 | 511 | Pass |
| | 249 | 512 | Pass |
| | 250 | 513 | Pass |
| | 251 | 514 | Pass |
| | 252 | 515 | Pass |
| | 253 | 516 | Failed |
| | 254 | 517 | Failed |

The multimedia device test method of the present invention tests the multimedia device by measuring the measured scan lines to make sure that the test result is reliable.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A multimedia device test method, comprising:
generating a reference signal and a measured signal by editing parameters thereof via a computer;
creating multiple sub-files of the reference signal and multiple sub-files of the measured signal according to corresponding parameters via the computer;
combining the multiple sub-files of the reference signal and the multiple sub-files of the measured signal into one composite file with a composite test signal via the computer;
compiling the file of the composite test signal as an object executable file via the computer;
executing the object executable file via a test signal generator for generating a frame including parameters of the composite test signal, and the frame is then transmitted to the multimedia device for outputting the composite test signal; and
providing an analyzer to analyze the output composite test signal.

2. The multimedia device test method as recited in claim 1, further comprising a step of setting a path and a name for the object executable file via the computer.

3. The multimedia device test method as recited in claim 2, further comprising a step of saving the object executable file into a storage device via the computer.

4. The multimedia device test method as recited in claim 3, further comprising a step of inputting the object executable file into the test signal generator from the storage device.

5. The multimedia device test method as recited in claim 1, wherein the sub-files of the reference signal and the sub-files of the measured signal comprise a sync level parameter.

6. The multimedia device test method as recited in claim 5, wherein the sub-files of the reference signal and the sub-files of the measured signal further comprise a color burst parameter.

7. The multimedia device test method as recited in claim 6, wherein the sub-files of the reference signal and the sub-files of the measured signal further comprise a white level parameter.

8. The multimedia device test method as recited in claim 1, wherein the frame comprises parameters of the reference signal and the measured signal.

9. The multimedia device test method as recited in claim 1, wherein the output composite test signal comprises multiple guard scan lines and multiple measured scan lines.

10. The multimedia device test method as recited in claim 1, wherein the analyzer analyzes the output composite test signal by measuring a color vector of the measured scan lines.

11. The multimedia device test method as recited in claim 1, wherein the frame generated by the test signal generator is a Moving Picture Experts Group (MPEG) frame.

12. A method for testing multimedia devices, comprising:
generating a reference signal, which is steadier during signal converting transmission, by editing parameters thereof;
generating a measured signal, which is selected randomly, by editing parameters thereof;
combining said reference signal and said measured signal into a composite test signal;
generating a frame including said composite test signal;
transmitting said frame to a multimedia device for outputting said composite test signal; and
analyzing said output composite test signal to retrieve test results for said multimedia device.

13. A method for testing multimedia devices, comprising:
generating a reference signal having a steadier property during signal converting transmission;
generating a measured signal for test use;
combining said reference signal and said measured signal into a composite test signal;
transmitting said composite test signal to a multimedia device for outputting said composite test signal; and
analyzing said output composite test signal to retrieve test results for said multimedia device.
